(19) United States
(12) Patent Application Publication
(10) Pub. No.: US 2023/0210142 A1
(43) Pub. Date: Jul. 6, 2023

(54) METHOD FOR PREPARING A COMESTIBLE PRODUCT

(71) Applicant: SOCIETE DES PRODUITS NESTLE S.A., Vevey (CH)

(72) Inventors: ROSA ARAGAO BORNER, Epalinges (CH); JEROEN ANDRE MULLER, Tengen (DE); JIYUAN ZHANG, Lausanne (CH)

(21) Appl. No.: 18/000,408

(22) PCT Filed: Jun. 3, 2021
(86) PCT No.: PCT/EP2021/064928

§ 371 Date: Dec. 1, 2022

(30) Foreign Application Priority Data
Jun. 8, 2020 (EP) 20178749.6

(51) Int. Cl. A23L 2/60; A23L 33/105; A23L 2/38

(52) U.S. Cl. CPC A23L 2/60; A23L 2/382; A23L 33/105

(57) ABSTRACT

The present invention relates to a method for preparing a comestible product, in particular a fermented beverage containing stevia extract. A further aspect of the invention is a comestible product obtainable by the method of the invention.

### FIELD OF THE INVENTION

The present invention relates to a method for preparing a comestible product, in particular a fermented beverage containing stevia extract. A further aspect of the invention is a comestible product obtainable by the method of the invention.

### BACKGROUND OF THE INVENTION

Food and beverage products containing simple extracts of stevia leaves or more purified steviol glycosides are increasingly popular. Stevia leaf extracts have a sweet taste, with the component steviol glycosides being many times sweeter than sucrose. However, the taste profile of stevia is not optimum for many consumers, having slow onset sweetness and a liquorice, bitter or lingering aftertaste. It would be beneficial to provide food and beverages containing stevia leaf extract with a more balanced flavour profile.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide an improved solution to overcome at least some of the inconveniences described above or at least to provide a useful alternative.The object of the present invention is achieved by the subject matter of the independent claims. The dependent claims further develop the idea of the present invention.

Accordingly, the present invention provides in a first aspect a method for preparing a comestible product, the method comprising; a) forming an aqueous mixture of stevia extract and a further aromatic plant material or extract thereof, by i) steeping stevia leaves and the further aromatic plant material together in water, or ii) steeping stevia leaves in water and adding an extract of the further aromatic plant material, or combining stevia extract with the further aromatic plant material, or an extract thereof, in water; b) optionally adding a fermentable sugar to the aqueous mixture formed in (a); and c) fermenting the mixture formed in (a) or (b) at a temperature below 33° C. with at least one yeast strain and at least one bacterial strain to form a fermented comestible product.

In a second aspect, the invention relates to a comestible product obtainable by the method of the invention.

It has been found by the inventors that when stevia leaves are used to make a tea (e.g. a hot infusion), and subsequently the tea is fermented with the addition of a little sugar, the resulting liquid is low in sugar, but due to the stevia is sweet. Surprisingly the stevia taste profile is much improved and the sweetness profile becomes very pleasant and similar to sucrose. Fermentation together with an aromatic plant material, such as tea, supplies other components for the microorganisms such as minerals and surprisingly enhances the overall flavour profile.

### BRIEF DESCRIPTION OF THE DRAWINGS

FIG. 1 shows the difference in sensory score for Sample 1a compared to Reference 1a without stevia, Sample 1b compared to Reference 1b without stevia and Reference 2 compared to Reference 3 without stevia. All comparison samples without stevia being assigned the value zero. The sensory attributes from top to bottom are “metallic”, “liquorice”, “astringent”, “bitter”, “sweet persistence”, “sweet maximum intensity” and “sweet onset”.

FIG. 2 shows the mean intensity scores for the Sample 1a, Sample 1b, Reference 2 and Reference 3 from Example 1. The sensory attributes from left to right are “sweet onset”, “sweet maximum intensity”, “sweet persistence”, “bitter”, “astringent”, “liquorice” and “metallic”. The letters A, B and C indicate statistical groupings of differences between samples.

### DETAILED DESCRIPTION OF THE INVENTION

Consequently, the present invention relates in part to a method for preparing a comestible product, the method comprising; a) forming an aqueous mixture of stevia extract and a further aromatic plant material or extract thereof, by i) steeping stevia leaves and the further aromatic plant material together in water, or ii) steeping stevia leaves in water and adding an extract of the further aromatic plant material, or iii) combining stevia extract with the further aromatic plant material, or an extract thereof, in water; b) optionally adding a fermentable sugar to the aqueous mixture formed in (a); and c) fermenting the mixture formed in (a) or (b) at a temperature below 33° C. with at least one yeast strain and at least one bacterial strain to form a fermented comestible product.

In the context of the present invention, stevia is the plant species Stevia rebaudiana.

In the context of the present invention the term “fermentation” refers to a process in which the activity of microorganisms brings about a change (typically a desirable change) to a foodstuff or beverage. The fermentation may be with yeasts and/or bacteria. The fermentation may be anaerobic or aerobic. Fermentation is one of the oldest means of preserving and enhancing foods.

The further aromatic plant material may be selected from the group consisting of coffee, tea (e.g. dried leaves, leaf-buds, twigs or stems of the plant Camellia sinensis), herbal tea (e.g. dried flowers, leaves, seeds or roots of plants other than Camellia sinensis), fruit and combinations of these. In an embodiment the further aromatic plant material is coffee or tea.

The further aromatic plant material may be coffee. The extract of the further aromatic plant material may be coffee extract, for example an aqueous extract of roast and ground coffee. The coffee may be arabica coffee (Coffea arabica), robusta coffee (Coffea canephora) or a blend of arabica and robusta coffee. The coffee extract may be in the form of a powder, such as soluble coffee.

The further aromatic plant material may be tea (e.g. dried leaves, leaf-buds, twigs or stems of the plant Camellia sinensis). The extract of the further aromatic plant material may be a tea infusion. The extract of the further aromatic plant material may be a tea powder formed by drying an aqueous extract of tea.

The further aromatic plant material may be fruit. In the context of the present invention the term fruit is used in the culinary sense of the word. Fruits are the fleshy seed-associated structures of a plant that are usually sweet and edible in the raw state, such as apples, oranges, grapes, strawberries and bananas. This includes fruits from cultivated varieties of plants which produce seedless fruits. The fruit may be in the form of a fruit concentrate, prepared fruit (for example peeled) or whole fruit (for example berries). The fruit may be crushed. The fruit may be stored frozen before being used in the method of the invention. In an embodiment, the extract of the further aromatic plant material is an aqueous fruit infusion.

The comestible product may be a food or beverage. In an embodiment the comestible product is a beverage. In an embodiment of the invention, the comestible product is a beverage and the method of the invention comprises; a) forming an aqueous mixture of stevia leaf extract and an extract of a further aromatic plant material, either by i) steeping stevia leaves and the further aromatic plant material together in water, or ii) steeping stevia leaves in water and adding an extract of the further aromatic plant material; b) adding a fermentable sugar to the aqueous mixture formed in (a); and c) fermenting the mixture formed in (b) at a temperature below 33° C. with at least one yeast strain and at least one bacterial strain to form a fermented beverage.

In an embodiment the stevia leaves are dried leaves. The stevia leaves may be in the form of stevia leaf powder.

The term steeping refers to immersing and soaking a material in liquid. Stevia leaves and the further aromatic plant material may be steeped together in water for at least 5 minutes, for example at least 10 minutes. The stevia leaves and the further aromatic plant material may be steeped together in water at a temperature from 60 to 110° C., for example from 90 to 100° C. Stevia leaves may be steeped in water for at least 5 minutes, for example at least 10 minutes. The stevia leaves may be steeped in water at a temperature from 60 to 110° C., for example from 90 to 100° C.

The stevia extract according to the invention may be a stevia leaf extract. The stevia extract according to the invention may be an aqueous extract from stevia leaves. The stevia extract according to the invention may have been extracted from stevia by organic solvent, for example ethanol. The stevia extract may comprise steviol glycosides (for example steviosides and rebaudiosides). The stevia extract may be purified steviol glycosides, for example the stevia extract may comprise at least 60 wt.% steviol glycosides, for example at least 70 wt.%, at least 80 wt.%, at least 90 wt.%, at least 95 wt.%, or at least 99 wt.% steviol glycosides. The steviol glycosides may not be in the same proportions as they are found in the stevia leaf, for example fractional crystallization may have been used to change the concentration of different steviol glycosides in the stevia extract. Preferably the steviol glycosides in the stevia extract are in the chemical form in which they occur in nature.

The concentration of steviol glycosides in the aqueous mixture of stevia extract and a further aromatic plant material or extract thereof according to the invention may be between 10 and 240 mg/L, for example between 20 and 200 mg/L, for example between 30 and 150 mg/L, for further example between 40 and 100 mg/L.

In an embodiment, the concentration of fermentable sugar before fermentation according to step (c) is between 0.5 and 25 wt.%. The quantity of fermentable sugar before fermentation in step (c) may be between 0.5 and 2 wt.% and the fermentation may proceed until such low levels of fermentable sugar remain that the fermentation stops. This provides a stable beverage after packaging.

A fermentable sugar is optionally added to the aqueous mixture formed in (a). In the event that the aqueous mixture formed in (a) already contains fermentable sugar (for example sufficient fermentable sugar to provide at least 0.5 wt.% fermentable sugar in the mixture before fermentation) it may not be not necessary to add fermentable sugar. In an embodiment the fermentable sugar is selected from the group consisting of glucose, fructose, sucrose, maltose and combinations of these. The fermentable sugar may be comprised within another ingredient such as honey, agave nectar or fruit puree. In an embodiment, the fermentable sugar is added to the aqueous mixture formed in a) at a concentration between 0.5 and 25 wt.%. Many consumers prefer comestible products with only small amounts of added sugar, so the fermentable sugar may be added at a low level, sufficient to provide a carbon source for the fermentation microorganisms. For example the fermentable sugar may be added to the aqueous mixture formed in a) at a concentration between 0.75 and 15 wt.%, for example between 1 and 10 wt.%. In an embodiment, the fermentable sugar is sucrose.

In an embodiment, fermenting the mixture according to step (c) is performed at a temperature between 15 and 33° C., for example between 28 and 32° C.

The fermentation according to the invention may be performed in the presence or absence of the steeped stevia leaves and/or steeped further aromatic plant material. For example the steeped stevia leaves and/or steeped further aromatic plant material may be removed from the aqueous mixture before fermentation, for example by decanting and/or filtration. In the event that the fermentation is performed in the presence of the steeped stevia leaves and/or steeped further aromatic plant material, the stevia leaves and/or steeped further aromatic plant material may be removed from the fermented beverage, for example by filtration.

The steeped further aromatic plant material may be dried after fermentation. The steeped, dried further aromatic plant material after fermentation may itself be used to prepare a comestible product such as a beverage by the addition of water, for example hot water. An aspect of the invention provides a beverage extractable composition for the preparation of a beverage comprising a dried aromatic plant material obtainable (for example obtained) by forming an aqueous mixture of stevia leaf extract and a further aromatic plant material; adding a fermentable sugar; fermenting the mixture at a temperature below 33° C. with at least one yeast strain and at least one bacterial strain; and drying the stevia leaf extract and a further aromatic plant material.

In an embodiment, the pH of the mixture formed in (b) may be adjusted to a value of 4 to 5.5 before fermentation.

The fermentation according to the invention may be performed until the fermentable sugar reduced by 25%, for example at least 40%, for example at least 60%, for example at least 80%, for example at least 99%. The fermentation may be performed until the fermentable sugar is reduced to below 7 wt.%, for example below 5 wt.%, for example below 3 wt.%, for example below 1 wt.%, for example below 0.3 wt.%, for further example below 0.1 wt.%.

In an embodiment, the mixture formed in (b) is inoculated with a culture containing 10⁴to 10¹⁰ yeast colony forming units and 10⁴ to 10¹⁰ bacteria colony forming units.

In the method of the invention, forming an aqueous mixture of stevia leaf extract and an extract of a further aromatic plant material may be by steeping stevia leaves and roast and ground coffee together in water. In the process of the invention, forming an aqueous mixture of stevia leaf extract and an extract of a further aromatic plant material may be by steeping stevia leaves and tea (the dried leaves, leaf-buds, twigs or stems of the plant Camellia sinensis) together in water.

In the method of the invention, forming an aqueous mixture of stevia leaf extract and an extract of a further aromatic plant material may be performed by steeping stevia leaves in water and adding coffee extract, for example by dissolving soluble coffee. In the process of the invention, forming an aqueous mixture of stevia leaf extract and an extract of a further aromatic plant material may be performed by steeping stevia leaves in water and adding cold brew coffee. In the context of the present invention, cold brew coffee is coffee extracted from roasted and ground coffee beans using water at a temperature of between 0 and 60° C.

In an embodiment the fermentation is performed by a culture of bacteria and yeast. The culture of bacteria and yeast may for example be a symbiotic culture. Several food and beverage products are fermented with symbiotic cultures of bacteria and yeast such as kombucha, kefir, ginger beer and sourdough. A Symbiotic Culture Of Bacteria and Yeast is sometimes abbreviated as SCOBY. Many symbiotic cultures, such as those in kombucha fermentation, produce a thick cellulosic biofilm on the liquid-air interface. The microbial community during fermentation is in two parts; the first one being a cellulosic biofilm or “pellicule” and the second one thriving in the underlying liquid. The inventors have surprisingly found that fermentation of an aqueous mixture of stevia leaf extract and an extract of a further aromatic plant material such as coffee or tea with a culture of bacteria and yeast produces a comestible product (for example a beverage) with an attractive balanced flavour profile. The culture of bacteria and yeast according to the invention may be a kombucha SCOBY. The culture of bacteria and yeast according to the invention may comprise a yeast selected from Dekkera bruxellensis, Zygosaccharomyces bailili, Zygosaccharomyces parabailii, members of the Pichiaceae family and combinations of these. The culture of bacteria and yeast according to the invention may comprise acetic acid bacteria, for example an acetic acid bacteria selected from Komagateibacter, Achromobacter and combinations of these.

As the method of the invention may be performed with low levels of fermentable sugar, the method does not require sugar tolerant bacteria and yeast. The culture of bacteria and yeast according to the invention may have low levels of Gluconobacter, for example by DNA extraction of the microbial culture, less than 5%, for example less than 1% of the DNA reads may be assigned to this taxonomic group. The culture of bacteria and yeast according to the invention may have low levels of Saccharomyces dairensis, for example by DNA extraction of the microbial culture, less than 5%, for example less than 1% of the DNA reads may be assigned to this taxonomic group. The culture of bacteria and yeast according to the invention may have low levels of Lactobacillus sporogenes, for example by DNA extraction of the microbial culture, less than 5%, for example less than 1% of the DNA reads may be assigned to this taxonomic group.

In an embodiment, the mixture formed in (b) is fermented with at least one yeast strain and at least one bacterial strain provided, at least in part, by the addition of some of the liquid from a previous fermentation. This technique is known as backslopping.

In an embodiment, the fermentation is performed for a period of at least 12 hours, for example at least 48 hours, for example at least 4 days, for example at least 7 days, for further example at least 10 days. The fermentation may be performed for a period between 3 and 15 days, for example between 5 and 14 days, for further example between 7 and 9 days.

In an embodiment the stevia leaves are steeped in water at a concentration of stevia leaf of from 0.05 to 1.5 wt.%, for example from 0.1 to 1 wt.%.

In an embodiment the aqueous mixture formed in step a) comprises from 0.05 to 3 wt.% aromatic plant material solids, for example from 0.1 to 1.5 wt.%.

In an embodiment the fermented comestible product (for example a beverage) is concentrated. For example the fermented mixture formed in c) may be concentrated. A concentrated fermented beverage can be sold as such for consumers to prepare their own beverage by adding water, or it may for example be shipped to bottling plants where water is added before bottling.

The bacteria and yeast in the fermented beverage may be removed or deactivated before the fermented comestible product (for example a beverage) is packaged. This aids the stability of the comestible product. In an embodiment the fermented comestible product is heat-treated at 85-140° C. for 30 seconds to 15 minutes and then packaged. In a further embodiment the fermented comestible product is a beverage which is filtered to remove at least some of the yeast and bacteria before being packaged. The packaging may be for example a bottle or can.

An aspect of the invention provides a comestible product obtainable (for example obtained) by the method of the invention. In an embodiment the comestible product is a beverage, for example a ready-to-drink beverage. The comestible product may be a packaged beverage, for example a ready-to-drink beverage such as a ready-to-drink beverage in a bottle or can.

The comestible product (such as a beverage) obtainable (for example obtained) by the method of the invention may comprise live bacteria and yeast, for example the bacteria and yeast used to ferment the comestible product. Live bacteria and yeast are associated with natural, health-giving products by consumers. The stability of the comestible product comprising live bacteria and yeast may be assured by allowing the fermentation to proceed until low levels of fermentable sugar remain and the fermentation stops.

The comestible product obtainable (for example obtained) by the method of the invention may be kombucha.

Those skilled in the art will understand that they can freely combine all features of the present invention disclosed herein. In particular, features described for the method of the present invention may be combined with the product of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1: Fermentation of Stevia Leaves with Black Tea

### Fermentation

Tea beverages were prepared with and without stevia leaf, and with and without fermentation.

A beverage was prepared by steeping either 2 g of black tea or, 2 g of black tea plus 3 g of stevia leaf powder, in 1 L boiling water for 10 minutes together with 80 g/L sucrose. The brew was cooled down below 40° C. before inoculation with a SCOBY pelicule plus 100 ml of backslop from a previous tea fermentation batch of the same composition. Such kombucha SCOBY cultures are found all around the world and are widely available, often passed freely from one enthusiast to another. The jars were incubated at 30° C. and fermented for 8 days. Monitoring of fermentation was done at different time points to control pH, °Brix, sugars consumption, acids and alcohol formation with an HPLC equipped with an Aminex column (Bio-Rad 87H).

As a control, the same brews were prepared but without inoculation and with the same sucrose concentration as the end point of the fermented brews (49-59 g/L sucrose).

Some of the fermented brews were pH neutralized after fermentation with food grade NaOH. This was done to evaluate the sensory effect without the interference of the acids.

The samples were:

| | |
|---|---|
| Sample 1a | black tea, sucrose and stevia fermented and maintained at its final pH of 3.4 |
| Reference 1a | black tea and sucrose, fermented and maintained at its final pH of 3.6 |
| Sample 1b | black tea, sucrose and stevia fermented and adjusted to pH 7 |
| Reference 1b | black tea and sucrose, fermented and adjusted to pH 7 |
| Reference 2 | black tea, sucrose and stevia, not fermented but sucrose adjusted to match fermented sample (pH around 7) |
| Reference 3 | black tea and sucrose, not fermented but sucrose adjusted to match fermented sample (pH around 7) |

### Microbial Community Characterization

The microbial community of kombucha starter cultures (SCOBY and liquid) was analyzed by high-throughput amplicon sequencing. Total microbial DNA was extracted from the SCOBY biofilm and from the liquid fraction (used as backslop in inoculum). The SCOBY biofilm cellulose was treated with a cellulase and followed by homogenization and centrifugation to collect cell pellets. Cell pellets from liquid fraction were also collected by centrifugation. All cell pellets were used for DNA extraction using Zymo kit. DNA quality and quantity were assessed with Qbit before library preparation for DNA sequencing.

For bacteria, the V3-V4 region of the 16S rRNA gene was amplified and sequenced by MiSeq Illumina technology and for yeast, the full length of ITS gen was amplified using Pacific Bioscience sequencing technology. Sequencing reads were assembled with DADA2 pipeline to attribute sequences to taxonomy.

The yeast community was found to be dominated by Dekkera bruxellensis, Zygosaccharomyces bailili, Zygosaccharomyces parabailii and members of the Pichiaceae family. The bacterial community was dominated by acetic acid bacteria such as Komagateibacter and Achromobacter.

### Sensory: Sweetness Time Intensity

Sensory analyses were performed by a trained panel.

Overall sweetness perception was decoupled in three different aspects enabling to characterize the sweetness from the first intake to the persistence few minutes after having spit the sample out. These three sweetness dimensions can be represented by three different questions: how fast? How intense? And how long? is the sweetness, and by the three following attributes:

1. the sweet onset (How fast?): time it takes until the sweetness is perceived, from weak onset (very long time) and strong onset (very short time)

2. the maximum intensity (How intense?): intensity of the sweetness when it reaches its maximum, from not intense to very intense.

3. the persistence (How long?): time it takes until the sweetness is not anymore perceivable, from short to long.

During the tasting, panelists are scoring the intensity of each independent attribute on linear scales (0-10) in the classical way.

### Sensory: Off-Taste Profiling

Sensory analyses were performed by a trained panel.

In addition to the sweetness profile, the following “off-tastes” usually caused by sweeteners have been evaluated : Bitterness ; Astringency ; Liquorice and Metallic. Therefore a monadic profiling was performed which consists in measuring the intensity of each of those sensory attributes on a 0-10 line scale. Products were evaluated one at a time for all the attributes. This methodology was used to establish the sweetness quality (e.g. sweetness dynamic profile and off-taste evaluation) of the different samples. The attributes used were: “Sweet” - Intensity of sweetness, sucrose as reference; “Liquorice” - A sensation normally perceived in the back and sides of the tongue; “Bitter” - Intensity of bitterness, quinine or caffeine as reference; “Astringent” - The feeling on the tongue or other skin surfaces of the oral cavity characterized by puckering/drying sensation. Associated with substances such as tannins; “Metallic” - Intensity of the metallic taste.

A two-way Analysis of Variance (ANOVA) was performed for each sensory attribute with samples as a fixed factor (product factor) and sensory panel as a random factor. As this test indicated significant differences between samples, Fisher’s Least Significant Difference (LSD) was calculated to determine the significance of the difference between any pair of samples. A 95% confidence level was applied these tests.

In order to better visualize the significant differences between the samples on the graphs, letters (e.g. A ; B ; C) were applied to each sample for each attribute in addition to the panel mean sensory score, based on the multiple comparison test (LSD). If a pair of samples don’t share the same letter, they can be considered as being significantly different from each other for a given attribute.

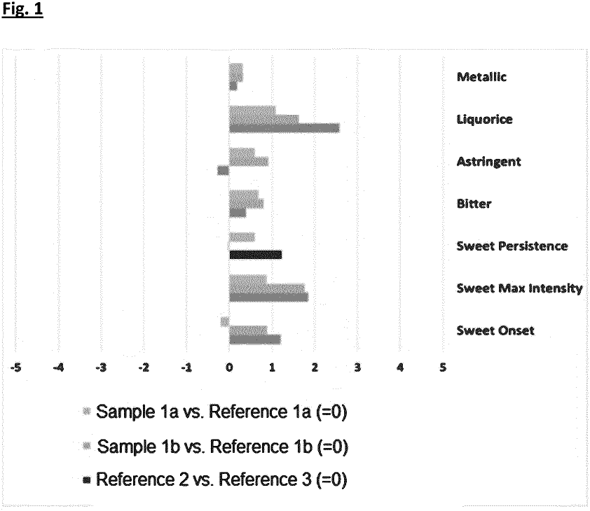

FIG. 1 shows the difference in sensory score for the samples compared to their respective reference without stevia (given a value of 0). It can be seen that, as adjusted to neutral pH, fermentation with tea reduces the sweetness persistence of the sample containing stevia (Sample 1b) to a similar level as the fermented sample with sucrose (Reference 1b), the difference being close to zero.

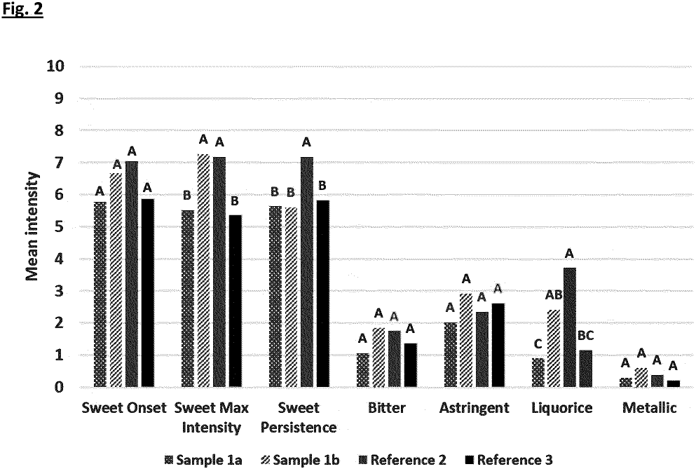

FIG. 2 shows the mean intensity scores for the samples. It can be seen that fermentation with tea tends to decrease the licorice notes derived from stevia. The positive effect on the sweetness quality by fermenting with tea is even more pronounced at lower pH.

1. A method for preparing a comestible product, the method comprising;
a) forming an aqueous mixture of stevia extract and a further aromatic plant material or extract thereof, by a step selected from the group consisting of
i) steeping stevia leaves and the further aromatic plant material together in water,
ii) steeping stevia leaves in water and adding an extract of the further aromatic plant material, and
iii) combining stevia extract with the further aromatic plant material, or an extract thereof, in water; and
b) fermenting the mixture formed in (a) at a temperature below 33° C. with at least one yeast strain and at least one bacterial strain to form a fermented comestible product.

2. The method of claim 1 wherein the comestible product is a beverage.

3. The method of claim 1 wherein the further aromatic plant material is coffee or tea.

4. The method of claim 1 wherein the fermentable sugar is sucrose.

5. The method of claim 1 wherein the fermentation is performed by a culture of bacteria and yeast being a kombucha SCOBY.

6. The method of claim 1 wherein the fermentation is performed for a period of at least 12 hours.

7. The method of claim 1 wherein the stevia leaves are steeped at a temperature between 60 and 110° C.

8. The method of claim 1 wherein the stevia leaves are steeped in water at a concentration of stevia leaf of from 0.05 to 1.5 wt.%.

9. The method of claim 1 wherein the aqueous mixture formed in step a) comprises from 0.05 to 3 wt.% aromatic plant material solids.

10. The method of claim 1 wherein the fermentable sugar is added to the aqueous mixture formed in a) at a concentration between 0.5 and 25 wt.%.

11. The method of claim 1 wherein the fermented comestible product is heat treated at 85-140° C. for 30 seconds to 15 minutes and then packaged.

12. The method of claim 1 wherein the fermented comestible product is concentrated.

13. A comestible product obtainable by the method of claim 1.

14-15. (canceled)
